(19) United States
(12) Patent Application Publication
(10) Pub. No.: US 2026/0088265 A1
(43) Pub. Date: Mar. 26, 2026

(54) NANOPARTICLE DETECTION THRESHOLD DETERMINATION THROUGH IONIC BACKGROUND REMOVAL

(71) Applicant: Elemental Scientific, Inc., Omaha, NE (US)

(72) Inventors: Myung Hwan Kim, Omaha, NE (US); Yuriy Shlapak, Omaha, NE (US)

(21) Appl. No.: 19/329,784

(22) Filed: Sep. 16, 2025

Related U.S. Application Data
(60) Provisional application No. 63/697,096, filed on Sep. 20, 2024.
(60) Provisional application No. 63/869,815, filed on Aug. 25, 2025.

(51) Int. Cl. H01J 49/00; H01J 49/02; H01J 49/04; H01J 49/10

(52) U.S. Cl. CPC H01J 49/0036; H01J 49/025; H01J 49/105; H01J 49/045

(57) ABSTRACT

Systems and methods for analyzing spectrometry data for the determination of nanoparticle detection thresholds are described. In an aspect, a method embodiment includes, but is not limited to, transferring a fluid sample containing nanoparticles to a spectrometry sample analyzer; generating a spectrometry data set via the spectrometry sample analyzer associated with detected ion signal intensity over time; establishing an ionic noise data set associated with background ion signal intensity by modeling the ionic noise as an exponential curve via regression analysis with a part of a frequency-intensity histogram of the spectrometry data set; and subtracting the ionic noise data set from the spectrometry data set to obtain a nanoparticle data set.

### CROSS-REFERENCE TO RELATED APPLICATIONS

The present application claims the benefit of 35 U.S.C. § 119 (c) of U.S. Provisional Application Ser. No. 63/697,096, filed Sep. 20, 2024, and titled “NANOPARTICLE DETECTION THRESHOLD DETERMINATION THROUGH IONIC BACKGROUND REMOVAL” and of U.S. Provisional Application Ser. No. 63/869,815, filed Aug. 25, 2025, and titled “NANOPARTICLE DETECTION THRESHOLD DETERMINATION THROUGH IONIC BACKGROUND REMOVAL.” U.S. Provisional Applications Ser. Nos. 63/697,096 and 63/869,815 are herein incorporated by reference in their entireties.

### BACKGROUND

Inductively coupled plasma (ICP) mass spectroscopy is an analysis technique commonly used for the determination of trace element concentrations and isotope ratios in liquid samples. ICP mass spectroscopy employs electromagnetically generated partially ionized argon plasma which reaches a temperature of approximately 7000K. When a sample is introduced to the plasma, the high temperature causes sample atoms to become ionized or emit light. Since each chemical element produces a characteristic mass or emission spectrum, measuring said spectra allows the determination of the elemental composition of the original sample.

Sample introduction systems may be employed to introduce the liquid samples into the ICP mass spectroscopy instrumentation (e.g., an inductively coupled plasma mass spectrometer (ICP/ICPMS), an inductively coupled plasma atomic emission spectrometer (ICP-AES), or the like) for analysis. For example, a sample introduction system may withdraw an aliquot of a liquid sample from a container and thereafter transport the aliquot to a nebulizer that converts the aliquot into a polydisperse aerosol suitable for ionization in plasma by the ICP mass spectrometry instrumentation. The aerosol is then sorted in a spray chamber to remove the larger aerosol particles. Upon leaving the spray chamber, the aerosol is introduced to the ICPMS or ICPAES instruments for analysis. Often, the sample introduction is automated to allow a large number of samples to be introduced into the ICP mass spectroscopy instrumentation in an efficient manner.

### SUMMARY

Systems and methods for analyzing spectrometry data for the determination of nanoparticle detection thresholds are described. In an aspect, a method embodiment includes, but is not limited to, transferring a fluid sample containing nanoparticles to a spectrometry sample analyzer; generating a spectrometry data set via the spectrometry sample analyzer associated with detected ion signal intensity over time; establishing, via one or more computer processors, an ionic noise data set associated with background ion signal intensity by modeling the ionic noise as an exponential curve via regression analysis with a part of a frequency-intensity histogram of the spectrometry data set; and subtracting, via the one or more computer processors, the ionic noise data set from the spectrometry data set to obtain a nanoparticle data set.

In an aspect, a system embodiment includes, but is not limited to, a spectrometry sample analyzer configured to receive a fluid sample containing nanoparticles from a sample source and to generate a spectrometry data set associated with detected ion signal intensity over time; one or more computer processors; and a non-transitory computer readable-medium bearing one or more instructions for execution by the one or more computer processors to cause the one or more computer processors to perform the steps of: generating a spectrometry data set via the spectrometry sample analyzer associated with detected ion signal intensity over time, establishing an ionic noise data set associated with background ion signal intensity by modeling the ionic noise as an exponential curve via regression analysis with a part of a frequency-intensity histogram of the spectrometry data set, and subtracting the ionic noise data set from the spectrometry data set to obtain a nanoparticle data set.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures.

FIG. 1A is a schematic illustration of a system for analysis of nanoparticles in accordance with example implementations of the present disclosure.

FIG. 1B is a partial diagrammatic illustration of the system of FIG. 1A in accordance with example implementations of the present disclosure.

FIG. 2 is a frequency vs. intensity histogram chart of an example spectrometry dataset shown with a detection threshold for nanoparticles separating data associated with ionic noise and nanoparticle in accordance with example implementations of the present disclosure.

FIG. 3 is a schematic illustration of a spectrometry data set shown with a frequency vs. intensity curve being composed of an ionic noise curve and a nanoparticle distribution curve in accordance with example implementations of the present disclosure.

FIG. 4 is a schematic illustration of a spectrometry data set shown with frequency vs. intensity curves for an ionic noise curve and a plurality of nanoparticle distribution curves for various silicon nanoparticle sizes in accordance with example implementations of the present disclosure.

FIG. 5 is a schematic illustration of a spectrometry data set shown with a first frequency vs. intensity curve being composed of an ionic noise curve and a nanoparticle distribution curve and a second frequency vs. intensity curve for an ionic noise curve, wherein a difference between the curves results in nanoparticle data from the first curve in accordance with example implementations of the present disclosure.

FIG. 6A is a frequency vs. intensity chart of an example spectrometry dataset shown with a detection threshold for nanoparticles inefficiently separating data associated with ionic noise and nanoparticles and associated data therefrom.

FIG. 6B is a frequency vs. intensity chart of an example spectrometry dataset shown with a detection threshold for nanoparticles separating data associated with ionic noise and nanoparticles and associated data therefrom in accordance with example implementations of the present disclosure.

FIG. 7A is a schematic illustration of a spectrometry data set shown with a frequency vs. intensity curve having a left edge and a right edge limit for the frequency to apply a regression analysis to determine factors of an exponential approximation for the ionic noise, where the right edge is close to the left edge, in accordance with example implementations of the present disclosure.

FIG. 7B is a schematic illustration of a spectrometry data set shown with a frequency vs. intensity curve having a left edge and a right edge limit for the frequency to apply a regression analysis to determine factors of an exponential approximation for the ionic noise, where the right edge extends into the portion of the histogram that includes nanoparticle data, which would result in a regression curve that is based on ionic noise and also on nanoparticle data, in accordance with example implementations of the present disclosure.

FIG. 7C is a schematic illustration of a spectrometry data set shown with a frequency vs. intensity curve having a left edge and a right edge limit for the frequency to apply a regression analysis to determine factors of an exponential approximation for the ionic noise, where the right edge is near but not substantially overlapping the portion of the histogram that includes nanoparticle data, in accordance with example implementations of the present disclosure.

FIG. 8A is a schematic illustration of a spectrometry data set shown with a frequency vs. intensity curve for the data set including nanoparticle and noise data, with a bar at a given frequency having a height on the frequency-intensity histogram representing a signal value for a signal-to-noise ratio determination, in accordance with example implementations of the present disclosure.

FIG. 8B is a schematic illustration of a spectrometry data set shown with a frequency vs. intensity curve for the data set representing noise data approximated as an exponential curve, with a bar at a given frequency having a height on the frequency-intensity histogram representing a noise value for a signal-to-noise ratio determination, in accordance with example implementations of the present disclosure.

FIG. 9 is a flow diagram for a method for the determination of nanoparticle detection thresholds based on treatment of ionic noise data as an exponential curve and based on signal-to-noise ratio analysis, in accordance with example implementations of the present disclosure.

FIG. 10A is a spectrometry data set for samples of 30 nm Si nanoparticles present in 2.45% sulfuric acid with utilization of the coefficient of determination (R²) with an R² limit of 0.995 for determination of the right end of the exponential curve, in accordance with example implementations of the present disclosure.

FIG. 10B is a spectrometry data set for samples of 30 nm Si nanoparticles present in 3.3% sulfuric acid with utilization of the coefficient of determination (R²) with an R² limit of 0.995 for determination of the right end of the exponential curve, in accordance with example implementations of the present disclosure.

FIG. 11A is a spectrometry data set for samples of 30 nm Si nanoparticles present in 2.45% sulfuric acid with utilization of the coefficient of determination (R²) with an R² limit of 0.99 for determination of the right end of the exponential curve, in accordance with example implementations of the present disclosure.

FIG. 11B is a spectrometry data set for samples of 30 nm Si nanoparticles present in 3.3% sulfuric acid with utilization of the coefficient of determination (R²) with an R² limit of 0.99 for determination of the right end of the exponential curve, in accordance with example implementations of the present disclosure.

FIG. 12A is a spectrometry data set for samples of 30 nm Si nanoparticles present in 2.45% sulfuric acid with utilization of a signal-to-noise ratio limit of 1.05 for determination of the right end of the exponential curve, in accordance with example implementations of the present disclosure.

FIG. 12B is a spectrometry data set for samples of 30 nm Si nanoparticles present in 3.3% sulfuric acid with utilization of a signal-to-noise ratio limit of 1.05 for determination of the right end of the exponential curve, in accordance with example implementations of the present disclosure.

### DETAILED DESCRIPTION

### Overview

Nanoparticle research has grown to encompass applications from the medical industry to the environmental industry. Such applications can focus on capabilities to detect nanoparticles (e.g., particles of less than 1000 nm in diameter) and to calculate the sizes of nanoparticles present in a sample. However, determining what is a nanoparticle and what is not a nanoparticle when analyzing spectrometry data poses many challenges. For instance, spectrometry data, such as ICPMS data, includes information associated with ionized samples and background interference. Background interference can result from ionization of plasma gases that introduced to the ICP torch along with the sample (e.g., aerosolized sample), where data associated with the background can overlap with data associated with small nanoparticles. For example, as the size of the nanoparticle decreases, the spectrometry data of the nanoparticle begins to converge with data associated with ionic species produced by the ICP torch. The nanoparticle signal convergence and the difficulty of isolating the nanoparticle data can further compound with dilute concentrations of acid sample matrices. This overlap and the associated challenges with removing background interferences, while avoiding nanoparticle data removal, lead to continued problems in providing reliable data associated with nanoparticles, including, but not limited to, identification of nanoparticles and determining the number of nanoparticles and their associated size distributions.

Accordingly, in one aspect, the present disclosure is directed to systems and methods for analyzing spectrometry data by treating spectrometry data that includes ionic noise and nanoparticle data together as a summation of two functions: a first function representing ionic noise and a second function representing the nanoparticle data. The nanoparticle data can be determined by removing the ionic noise from the original data set including both the ionic noise data and the nanoparticle data, which can facilitate the determination of nanoparticle detection thresholds. In aspects, the intensity vs frequency curve of the ionic noise is treated as an exponential curve, with an interval intensity chosen to determine properties of the exponential curve (e.g., via least squares fit, via weighted least squares fit, etc.). For instance, a subset of the original data having lower intensity counts (e.g., prior to expected nanoparticle data) can be utilized as the interval intensities. The resultant properties can then be utilized to model the entire curve of the ionic noise. The ionic noise curve can then be subtracted from the original data to provide the nanoparticle data.

In aspects, the original data set is treated by subtracting from the spectrometry data set a background intensity value prior to analyzing the interval intensity. In aspects, following removal of the ionic noise from the original data set, the nanoparticle detection threshold can be determined as a positive frequency value that follows on the intensity axis two consecutive frequency values that are less than a threshold frequency. The threshold frequency can be zero (i.e., two negative frequency values preceding a positive frequency value), or a relatively small frequency value (e.g., from 0 to 10).

In aspects, the interval intensity used to determine the properties of the exponential curve is based on a signal-to-noise ratio (“S/N”) analysis of the original data set including both the ionic noise data and the nanoparticle data as the signal in the S/N analysis and of the exponential curve representing the ionic noise as the noise in the S/N analysis. For instance, the signal-to-noise ratio can be calculated based on a given intensity on the frequency-intensity histogram of the original data set and on the value of the ionic noise calculated from the exponential model at the given intensity. The nanoparticle threshold is then determined by considering the bars of the histogram from the right to the left and finding the first occurrence where two or more bars in a row have a signal-to-noise ratio that is below a threshold signal-to-noise ratio. For instance, by selecting a threshold signal-to-noise ratio of 1.05, bars on the histogram are selected to incorporate nanoparticle data that have a signal that is at least 5% greater than the projected ionic noise. By selecting the nanoparticle threshold in this manner, the bars whose frequency is greater than the frequency of the calculated ionic noise are included in the nanoparticle portion of the initial histogram, with the difference between these frequences being attributed to the presence of nanoparticles.

### Example Implementations

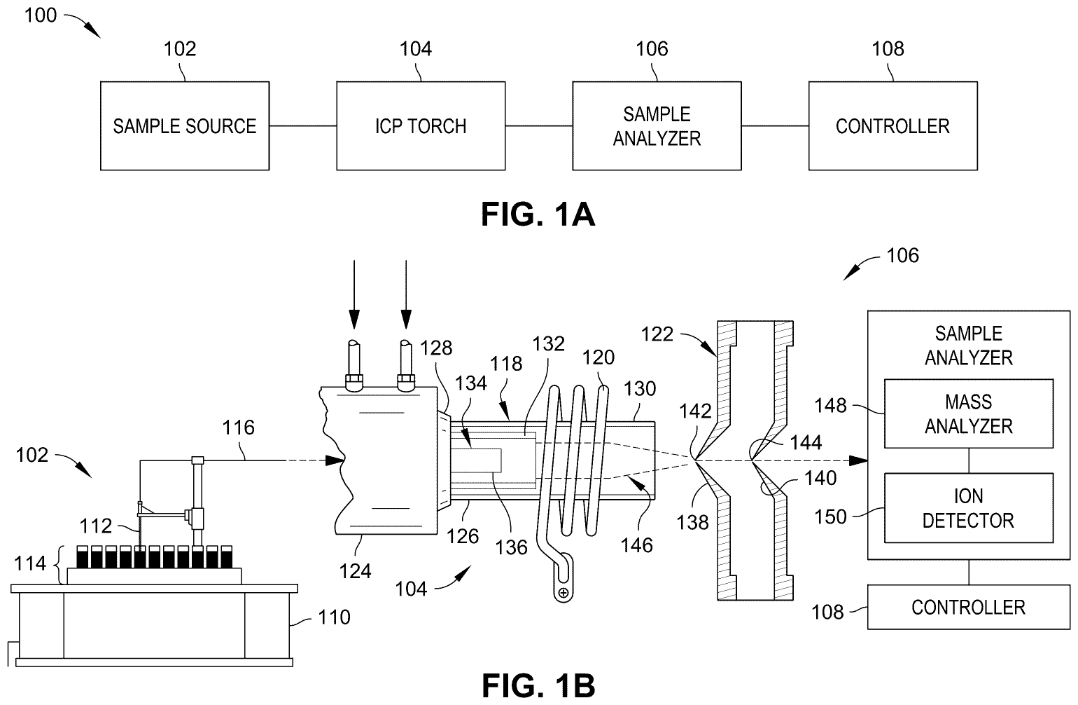

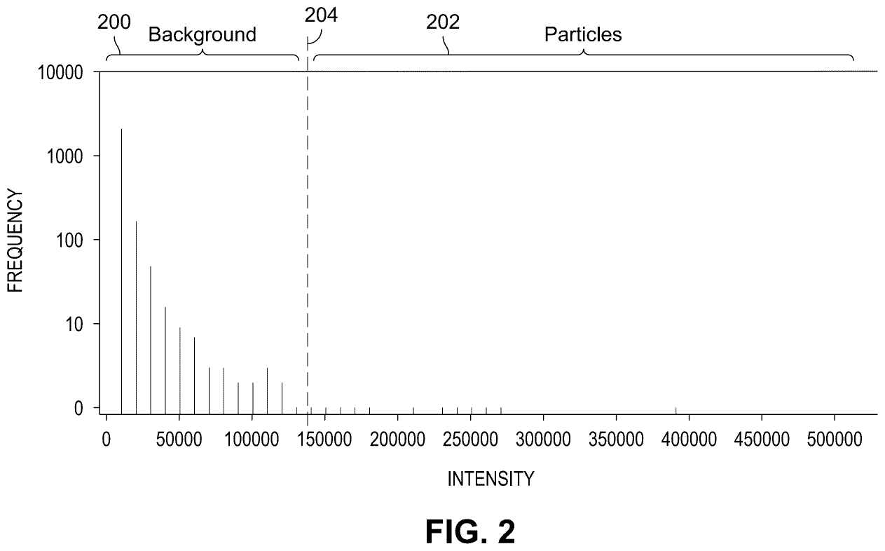

Referring generally to FIGS. 1A through 12B, a process is shown for analyzing spectrometry data via ionic noise removal for the determination of nanoparticle detection thresholds in accordance with example implementations of the present disclosure. The instant disclosure provides description of an example system for analysis of nanoparticles in FIGS. 1A and 1B and of example data processes in FIGS. 2 through 12B to treat spectrometry data including both ionic noise and nanoparticle data to remove ionic noise from the spectrometry data.

Referring to FIGS. 1A and 1B, a system 100 for analysis of nanoparticles contained in fluid samples is shown in accordance with example implementations of the present disclosure. The system 100 generally includes a sample source 102, an inductively coupled plasma (ICP) torch 104, a sample analyzer 106, and a controller 108. The sample source 102 supplies a fluid sample containing nanoparticles for analysis by the sample analyzer 106 and can include, for example, an autosampler (e.g., autosampler 110 shown in FIG. 1B) to automate fluid handling of the sample. For instance, the autosampler 110 manipulates a sample probe 112 to draw fluid samples held in fluid containers 114 (e.g., sample vials, sample bottles, etc.) and transfer the fluid samples from the autosampler to other portions of the system, such as through vacuum transfer, pump transfer, or the like. The samples can include fluids containing nanoparticles of interest, diluents, sample matrix components, components for generation of calibration curves (e.g., standard fluids, standard nanoparticles, etc.), or the like, or combinations thereof. In implementations, the controller 108 facilitates control of one or more aspects of the fluid transfer from the autosampler 110. In implementations, the controller 108 includes a computer processor communicatively coupled with a computer memory to access control programming associated with one or more processes described herein for execution by the computer processor.

The sample source 102 is fluidically coupled with the ICP torch 104 (e.g., via a fluid transfer line 116) to transfer the fluid sample containing nanoparticles to the ICP torch 104 for ionization of the sample for analysis by the sample analyzer 106. In implementations, the sample source 102 includes one or more sample conditioning systems to prepare the fluid sample for introduction to the ICP torch 104. For example, the sample source 102 can include a nebulizer to receive the fluid sample from the autosampler 110 and aerosolize the fluid sample and a spray chamber to receive the aerosolized sample from the nebulizer and remove larger aerosol components through impact against spray chamber walls. The sample source 102 can thus condition the fluid sample to promote substantially continuous operation of the ICP torch 104 for sample ionization, such as by aerosolizing the sample and removing larger aerosol components to prevent extinguishing of the plasma generated by the ICP torch 104.

An example ICP torch 104 is shown in FIG. 1B, where the system 100 is shown including a plasma torch assembly 118, a radio frequency (RF) induction coil 120 that is coupled to an RF generator (not shown), and an interface 122. The plasma torch assembly 118 includes a housing 124 that receives a plasma torch 126 configured to sustain the plasma. The plasma torch 126 is shown including a torch body 128, a first (outer) tube 130, a second (intermediate) tube 132, and an injector assembly 134 which includes a third (injector) tube 136. The plasma torch 126 is mounted by the housing 124 for positioning centrally in the RF induction coil 120 so that the end of the first (outer) tube 130 is adjacent to (e.g., approximately 10-20 mm from) the interface 122. The interface 122, which can be included in the sample analyzer 106 or as a separate component thereof, generally includes a sampler cone 138 positioned adjacent to the plasma and a skimmer cone 140 positioned adjacent to the sampler cone 138, opposite the plasma. A small diameter opening 142, 144 is formed in each cone 138, 140 at the apex of the cone 138, 140 to allow the passage of ions from the inductively coupled plasma for analysis by the sample analyzer 106.

A flow of gas (e.g., the plasma-forming gas), which is used to form the plasma (e.g., plasma 146), is passed between the first (outer) tube 130 and the second (intermediate) tube 132. A second flow of gas (e.g., the auxiliary gas) is passed between the second (intermediate) tube 132 and the third (injector) tube 136 of the injector assembly 134. The second flow of gas can be used to change the position of the base of the plasma relative to the ends of the second (intermediate) tube 132 and the third (injector) tube 136. In implementations, the plasma-forming gas and the auxiliary gas include argon (Ar), however other gases may be used instead of or in addition to argon (Ar), in specific implementations. The RF induction coil 120 surrounds the first (outer) tube 130 of the plasma torch 126. RF power (e.g., 750-1500 W) is applied to the coil 120 to generate an alternating current within the coil 120. Oscillation of this alternating current (e.g., 27 MHz, 40 MHz, etc.) causes an electromagnetic field to be created in the plasma-forming gas within the first (outer) tube 130 of the plasma torch 126 to form an ICP discharge through inductive coupling. A carrier gas is then introduced into the third (injector) tube 136 of the injector assembly 134. The carrier gas passes through the center of the plasma, where it forms a channel that is cooler than the surrounding plasma. Samples to be analyzed are introduced into the carrier gas for transport into the plasma region, where the samples can be formed into an aerosol of liquid by passing the liquid sample from the sample source 102 into a nebulizer. As a droplet of nebulized sample enters the central channel of the ICP, it evaporates and any solids that were dissolved or carried in the liquid vaporize and then break down into atoms. In implementations, the carrier gas includes argon (Ar), however, other gases may be used instead of, or in addition to, argon (Ar) in specific implementations.

The sample analyzer 106 generally includes a mass analyzer 148 and an ion detector 150 to analyze the ions received from the ICP torch 104. For example, the sample analyzer 106 can direct ions received from the plasma of the ICP torch 104 and directed through the cones 138, 140 to the mass analyzer 148. The sample analyzer 106 can include various ion conditioning components, including, but not limited to, ion guides, vacuum chambers, reaction cells, and the like, suitable for operation of an ICPMS system. The mass analyzer 148 separates ions based on differing mass to charge ratios (m/z). For instance, the mass analyzer 148 can include a quadrupole mass analyzer, a time of flight mass analyzer, or the like. The ion detector 150 receives the separated ions from the mass analyzer 148 to detect and count ions according to the separated m/z ratios and output a detection signal. The controller 108 can receive the detection signal from the ion detector 150 to coordinate data for determination of the concentration of components in the ionized sample according to intensity of the signals of each ion detected by the ion detector 150 and for the determination of nanoparticle characteristics for nanoparticles contained in the fluid sample (e.g., nanoparticle size, nanoparticle amount, etc.).

An example spectroscopy data set from the controller 108 is shown in FIG. 2 as a histogram of frequency vs. intensity values. The histogram can be generated by performing an initial baseline intensity subtraction of the spectroscopy data set from the controller 108 followed by integration of intensity peaks to provide the bars on the frequency vs. intensity histogram. For example, the raw data set from the controller 108 includes an intensity over time data set provided by an ICPMS, where an initial set of baseline intensities are removed from the raw data set. In implementations, the data set is integrated following removal of the background from the raw data set. For example, time-consecutive non-zero data points for detected intensity are summed together, where the data points can be considered to be time-consecutive when no intervening zero value is detected by the ICPMS for a given time detection interval, such as a detection interval of 0.01 secs. By integrating after background removal, more zero data points can be present since the background removal can filter out lower non-zero data points from the raw data set to provide zero values. The integrated values are then assigned to bins with particular intensity intervals (e.g., bins having intensity intervals of 10,000 counts per second (cps)) to determine a frequency of the intensity values and provide the bars on the histogram.

The histogram of FIG. 2 is a spectrometry data set that is shown containing portions of data attributable to ionic content (i.e., “ionic noise” shown as 200) and portions of data attributable to nanoparticles present in the sample fluid (i.e., “particles” shown as 202). The ionic noise 200 is separated from the nanoparticle data 202 by a nanoparticle threshold 204, an intensity after which data is likely attributable to nanoparticles instead of ionic interference.

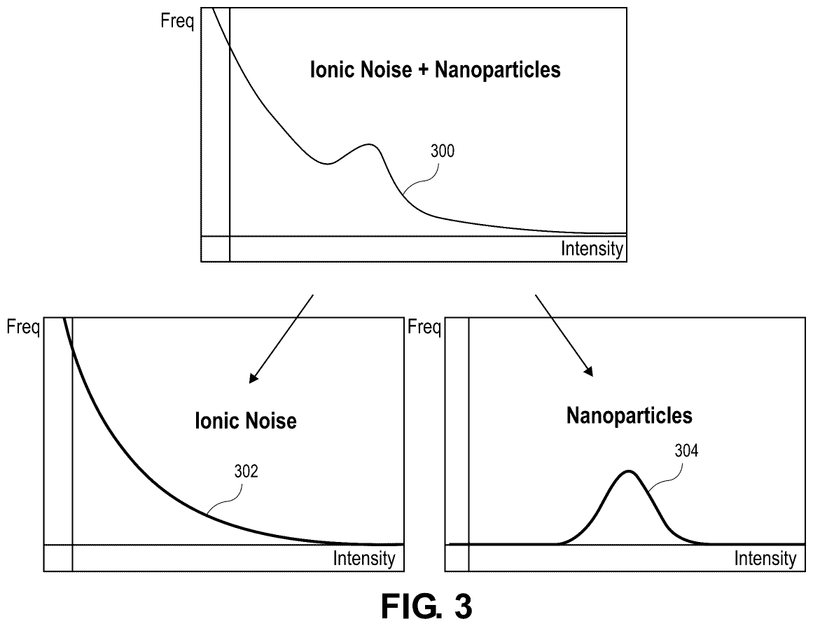

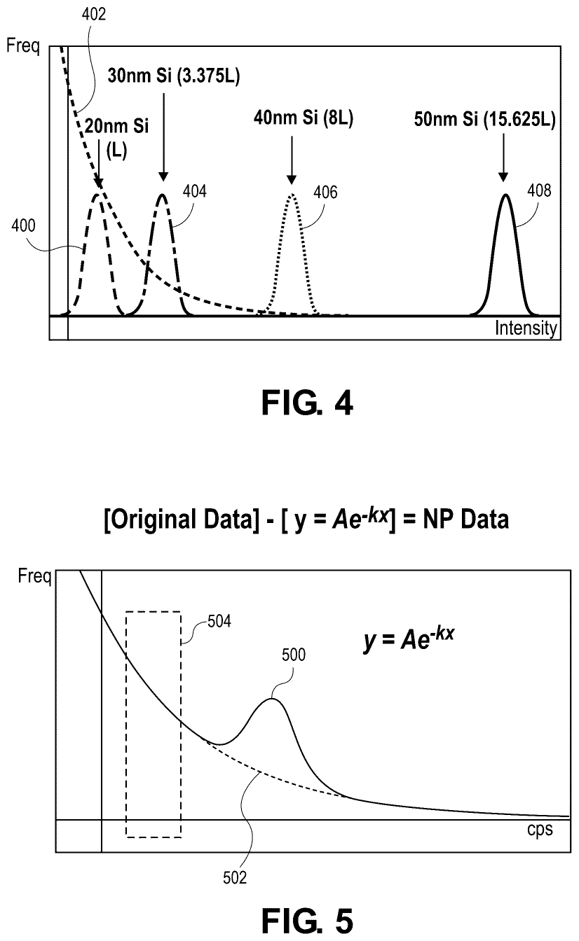

In implementations, ionic content present in a sample analyzed by spectrometry, such as ICPMS, can be treated as an exponential curve present in the spectrometry data corresponding to a combination of the ionic noise and the nanoparticle data. For example, referring to FIG. 3, a spectrometry data set is shown with an initial frequency vs. intensity curve 300 being composed of an ionic noise curve 302 and a nanoparticle distribution curve 304 in accordance with example implementations of the present disclosure. The initial frequency vs. intensity curve 300 is treated as a summation of two functions: a first function representing ionic noise and a second function representing the nanoparticle data. However, as nanoparticle size decreases, the positioning of the data associated with detection of the smaller nanoparticles on the frequency vs. intensity chart begins to overlap with the ionic noise. For example, referring to FIG. 4, a sample containing 20 nm silicon nanoparticles generates frequency vs. intensity curve data that is underneath the ionic noise curve 402, with 30 nm Si and 40 nm Si each showcasing data (shown as 404, 406 respectively) that at least partially overlaps with the ionic noise curve. The 50 nm Si data (shown as 408) is substantially separate from the ionic noise curve 402 due in part to the ability of the ICPMS to distinguish these larger nanoparticles relative to the smaller nanoparticles, particularly where the ionic noise curve 402 generally decays as the intensity increases.

Referring to FIG. 5, an initial frequency vs. intensity curve is shown (indicated as 500) with an ionic noise curve (indicated as 502) modeled as an exponential curve overlaid with the initial data curve. In implementations, the exponential curve is represented by equation (1):

$$y = A {e}^{- k x} \qquad ( 1 )$$

where y represents the frequency of counts, x represents the intensity of counts (e.g., in counts per second (cps)), and A and k are factors determinable through a regression analysis of a portion of the frequency vs. intensity curve. For example, a least squares fit analysis can be applied to a portion of the frequency vs. intensity curve to determine the factors of the exponential curve. However, the present disclosure is not limited to least squares fit and can include other analyses including, but not limited to, a weighted least squares fit.

The interval intensity to which the regression analysis is applied is chosen to determine the properties of the exponential curve, where the interval can be a subset of the original data having lower intensity counts (e.g., prior to expected nanoparticle data). For example, FIG. 5 shows the interval intensity as the dashed box (indicated as 504) to take data from the initial data curve 500 of the histogram for least squares fit analysis to solve for A and k of the exponential curve of the ionic noise. In implementations, the interval intensity or the right edge of the interval intensity can be manually selected by a user or can be automatically determined. For instance, an automatic process for determining the right edge of the interval intensity can include determining a minimum value of a coefficient of determination (R²) of the regression curve of the linear least squares fit (e.g., on the logarithmic scale of the data). The automatic method creates a sequence of exponential curves based on equation (1) for the interval intensity beginning at a fixed left edge and with the right edge increasing for each exponential curve of the sequence. For example, the left edge for each exponential curve can be an intensity value of 20,000 cps and the right edge can be increased by an increment of 10,000 cps for each exponential curve of the sequence (e.g., with a first exponential curve determined with a right edge value of 40,000 cps, a second exponential curve determined with a right edge value of 50,000 cps, a third exponential curve determined with a right edge value of 50,000 cps, and so forth). The method continues calculating the exponential curves until the regression line on the logarithmic scale has a coefficient of determination (R²) that exceeds a specified value (e.g., greater than R²=0.995).

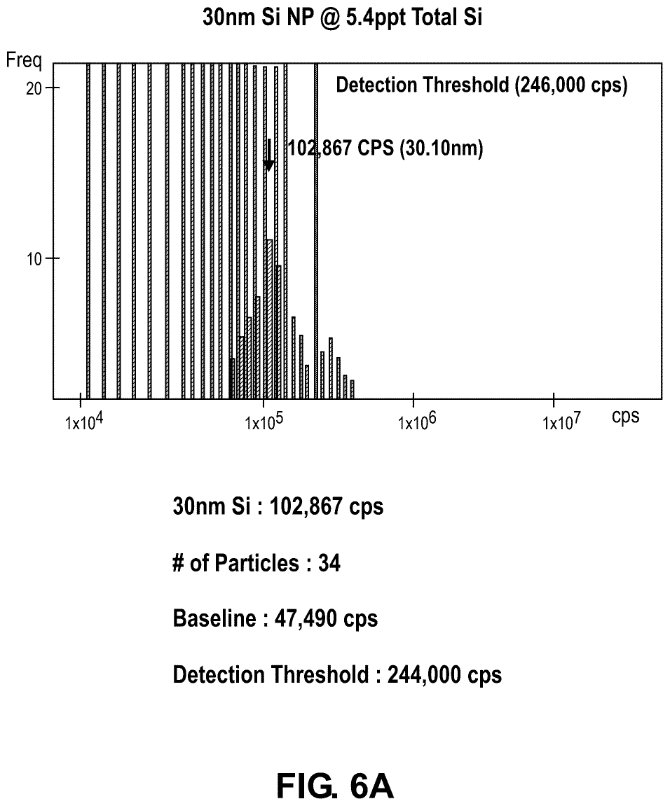

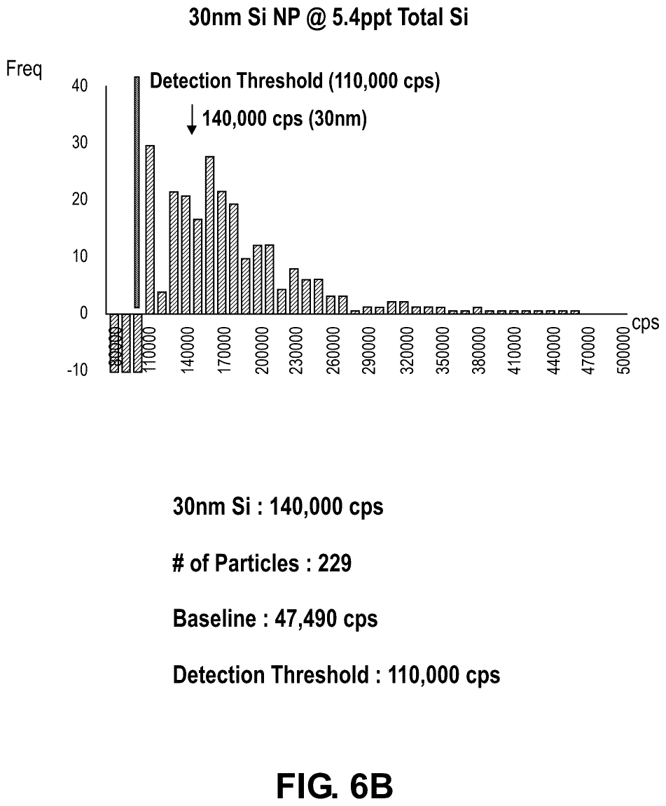

Upon determination of the properties of the ionic noise curve 502, the ionic noise curve 502 can be subtracted from the initial data curve 500 to obtain the nanoparticle data. Referring to FIGS. 6A and 6B, example datasets are provided that show treatment of a spectrometry dataset with a differing ionic noise treatment method (e.g., local minimum analysis) versus treatment of the spectrometry dataset with the ionic noise removal techniques described herein, where the sample included 30 nm silicon nanoparticles present in 4.9% H₂SO₄ in an amount of 5.4 ppt. A local minimum analysis technique to determine a detection threshold of nanoparticles in FIG. 6A resulted in 102,867 cps of 30 nm Si, with a particle count of 34, and a detection threshold of 244,000 cps, whereas the ionic noise removal technique in FIG. 6B resulted in 140,000 cps of 30 nm Si, with a particle count of 229, and a detection threshold of 110,000 cps, accounting for a significant increase in detection of the amount of 30 nm nanoparticles present in the liquid sample.

In aspects, following removal of the ionic noise from the original data set to provide a nanoparticle dataset, the nanoparticle detection threshold can be determined as a positive frequency value of the nanoparticle dataset that follows on the intensity axis two consecutive frequency values that are less than a threshold frequency. The threshold frequency can be zero (i.e., two negative frequency values preceding a positive frequency value), or a relatively small frequency value (e.g., from 0 to 10). For example, referring to FIG. 6B, the detection threshold of 110,000 cps follows two preceding negative frequency values at 100,000 cps and 90,000 cps. However, the present disclosure can utilize a variety of windows to determine the transition between frequency values to establish the nanoparticle detection threshold. For instance, the histogram of the nanoparticle dataset can be analyzed from right to left to determine a certain number of consecutive intensity values (i.e., bars on the histogram) that are below a threshold frequency. For example, the method can include determining where two consecutive values are below the threshold frequency, where three consecutive values are below the threshold frequency, where one value is below the threshold frequency, where four consecutive values are below the threshold frequency, or so forth, with the nanoparticle detection threshold being set as the intensity value to the right of the last intensity value in the window.

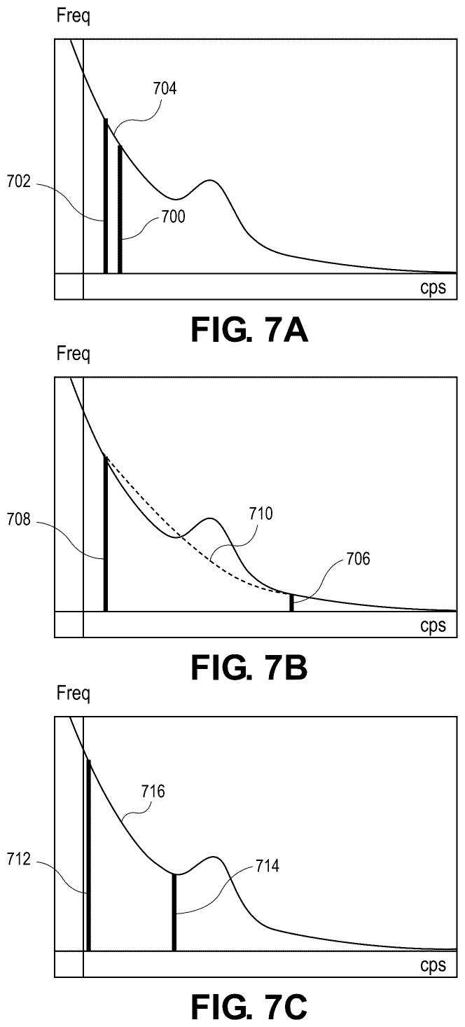

However, determination of the right edge of the interval intensity used to calculate the ionic noise curve based on the exponential curve analysis can be problematic, such as if the right edge of the interval intensity would be selected or calculated to fall within the portion of the spectrometry data associated with nanoparticles or if the right edge is too close to the left edge. For instance, referring to FIGS. 7A through 7C, frequency vs intensity charts are shown for a spectrometry dataset, each with a different right edge of the interval intensity. In FIG. 7A, the right edge 700 of the interval intensity is too close to the left edge 702 of the interval intensity, which would result in a regression curve 704 (e.g., according to equation (1)) that is based on a potentially insufficient number of bars of the histogram. In FIG. 7B, the right edge 706 of the interval intensity extends too far from the left edge 708 into the portion of the histogram that includes nanoparticle data, which would result in a regression curve 710 (e.g., according to equation (1)) that is based on ionic noise and also on nanoparticle data. In FIG. 7C, the left edge 712 of the interval intensity is close to zero, with the right edge 714 of the interval intensity going to the right before entering into the nanoparticle portion of the histogram, which would result in a regression curve 716 (e.g., according to equation (1)) that is based on a significant number of data points associated with ionic noise while avoiding inclusion of nanoparticle data.

While the automatic method for determination of the right edge of the interval intensity described herein creates a sequence of exponential curves based on equation (1) for the interval intensity beginning at a fixed left edge and with the right edge increasing for each exponential curve of the sequence, such method utilizing the coefficient of determination (R²) can obfuscate the determination of the limit of where the nanoparticle data begins, particularly since the exponential curve becomes a linear function on a logarithmic scale, causing the logarithmic values to be compared against each other. Further, using the coefficient of determination (R²) (on a logarithmic scale) to find the right limit of the interval intensity to define the ionic noise curve does not guarantee that right limit will be located outside of the nanoparticle part of the histogram, which can result in ionic noise curves that include nanoparticle data, such as those shown in FIG. 7B.

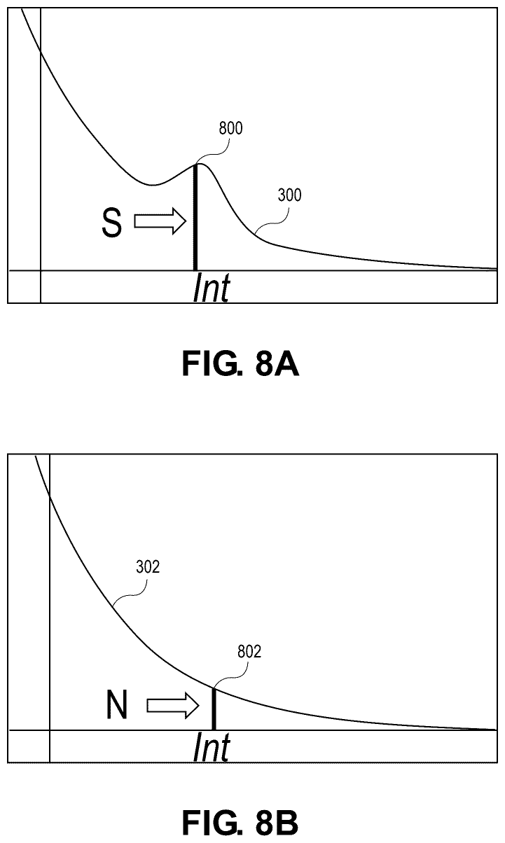

To facilitate determination of the right edge of the interval intensity and associated nanoparticle thresholds, the methods described herein can utilize a signal-to-noise ratio (“S/N”) analysis of the frequency-intensity histogram with the value of the ionic noise calculated from the exponential model (e.g., according to equation (1)) at a given intensity. Such signal-to-noise ratio analysis provides an comparative analysis in the linear scale of frequency, instead of utilizing the coefficient of determination (R²), which is a comparative analysis in the logarithmic scale. The linear scale comparative analysis makes differentiation between data more apparent as compared to comparative analysis in the logarithmic scale. For instance, the signal can correspond to the height of the bar on the frequency-intensity histogram (e.g., shown as 800 in FIG. 8A), whereas the noise can correspond to the calculated frequency of the ionic noise (e.g., from equation (1), shown as 802) that corresponds to the intensity of that bar (e.g., shown in FIG. 8B). The method can proceed by calculating the signal-to-noise ratio for each bar of the frequency-intensity histogram by dividing the height (i.e., frequency) of that bar on the frequency-intensity histogram by the value of the calculated frequency of the ionic noise at the level of intensity that corresponds to that bar. For example, in the frequency-intensity histogram shown in FIG. 8A, the bar that corresponds to intensity 120,000 has frequency 130. The calculated ionic noise frequency at the level of intensity 120,000 is 126.5225 utilizing equation (1), shown in FIG. 8B. Hence, the signal-to-noise ratio for the level of intensity 120,000 on the histogram is 130/126.5225=1.0274852299.

The nanoparticle threshold can be determined by considering the bars of the histogram from the right to the left and finding the first occurrence where one or more bars in a row have a signal-to-noise ratio that is below the threshold signal-to-noise ratio. To filter out histogram bars with zero frequency (i.e., that would have a signal-to-noise ratio that would be zero), the method can consider the bars whose signal-to-noise ratio is above some small positive value, for example above 0.01 or 0.001, etc. For example, the method can filter out bars having a signal-to-noise ratio of zero, leaving data for the nanoparticle threshold determination based on histogram bars having a non-zero frequency. In implementations, the threshold signal-to-noise ratio is equal to or slightly greater than 1, for example 1.05, 1.075, 1.1, or the like. By setting the threshold signal-to-noise ratio to a value greater than 1, the method builds in margin to eliminate random fluctuations often found in data attributable to noise, which adds practical stability and potential user discretion to the analysis, such as by permitting selection of differing threshold signal-to-noise ratios. For instance, by selecting a threshold signal-to-noise ratio of 1.05, bars on the histogram are selected to incorporate nanoparticle data that have a signal that is at least 5% greater than the projected ionic noise. By selecting the nanoparticle threshold in this manner, the bars whose frequency is greater than the frequency of the calculated ionic noise are included in the nanoparticle portion of the initial histogram, with the difference between these frequences being attributed to the presence of nanoparticles.

As a safeguard in the determination of the right edge of the interval intensity, the methods described herein can limit bars of the histogram to those bars below the nanoparticle threshold when determining the ionic noise curve by the least squares fit. For example, the method can generate a sequence of ionic noise curves, each ionic noise curve one using equation (1) and corresponding regression analysis (e.g., via least squares fit, etc.) based on the set of bars from the histogram, where the leftmost bar of the set is the same, and the rightmost bar is being moved to the right as the sequence progresses along the intensity axis. For each curve in this sequence, the nanoparticle threshold can be determined, and the method explicitly checks whether the right end of the set of bars lies below the nanoparticle threshold determined using the specific ionic noise curve. The final ionic noise curve can then be selected based on the largest set of bars whose rightmost bar is below the nanoparticle threshold, and this final ionic noise curve can be used for determining the nanoparticle threshold for the given histogram.

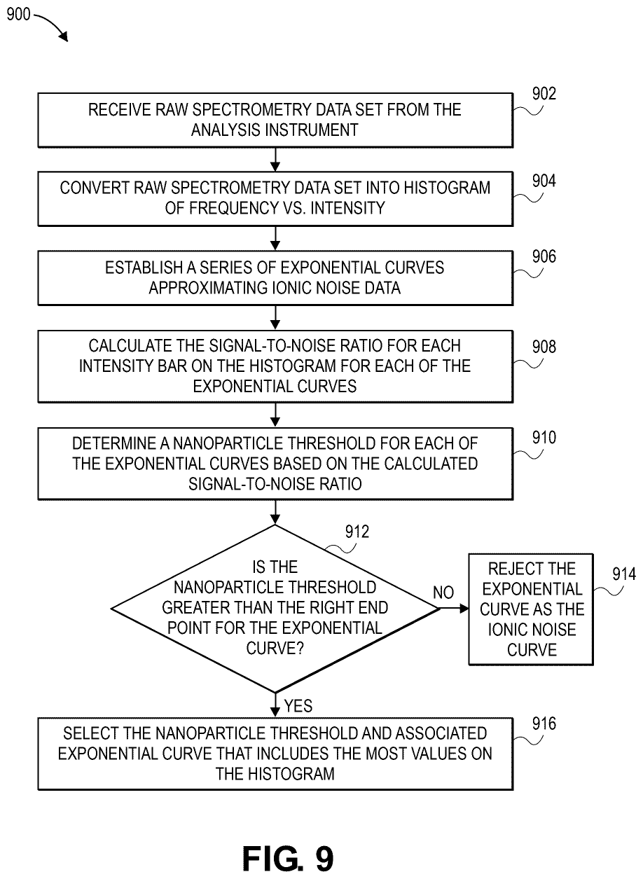

An example method for the determination of nanoparticle detection thresholds based on treatment of ionic noise data as an exponential curve and based on signal-to-noise ratio analysis (“method 900”) is shown with respect to FIG. 9. The method 900 includes receiving a raw spectrometry data set from an analytical instrument in block 902. For example, the raw spectrometry data set can include an intensity over time data set provided by a spectrometer, such as an ICPMS. In implementations, the raw spectrometry data set is transferred from the sample analyzer 106 to the controller 108 for implementation of the method 900 or portions thereof.

The method 900 also includes converting the raw spectrometry data set into a histogram of frequency vs. intensity in block 904. For example, the controller 108 can remove a baseline intensity value from each of the intensities in the intensity over time data set from the analytical instrument and then integrate the remaining positive (e.g., non-zero) intensities, such as by summing time-consecutive non-zero data points and assigning the integrated intensity values to bins having particular intensity intervals (e.g., bins having intensity intervals of 10,000 counts per second (cps)) to determine a frequency of the intensity values and provide the bars on the histogram.

The method 900 also includes establishing a series of exponential curves approximating ionic noise data in block 906. For example, the controller 108 can process the histogram data according to equation (1) to treat the ionic noise data as an exponential curve, where the interval of the histogram data is selected with a common left end and where each successive exponential curve increases the right end to generate multiple exponential curves. For instance, the right end point (e.g., shown as 700, 706, 714 in FIGS. 7A, 7B, and 7C, respectively) can progress from intensity values close to the left end (e.g., shown as 702, 708, 712 in FIGS. 7A, 7B, and 7C, respectively) and progress to higher intensity values for each iteration of the exponential curve calculation. As an example, the right end points can progress from 30000 cps, 40000 cps, 50000 cps, 60000 cps, etc. to provide a first ionic noise curve calculated between [10000,30000], a second ionic noise curve calculated between [10000,40000], a third ionic noise curve calculated between [10000,50000], a fourth ionic noise curve calculated between [10000,60000], and so forth. Alternatively or additionally, the right end points could be calculated according to any beginning point or progression of points along the intensity bars of the histogram.

The method 900 also includes calculating the signal-to-noise ratio for each intensity bar on the histogram for each of the exponential curves in block 908. For example, the controller 108 can assign the signal value as the height of the bar on the frequency-intensity histogram for a given intensity (e.g., as shown in FIG. 8A) and can assign the noise value as the calculated frequency of the ionic noise that corresponds to the same intensity based on the equation (1) with the specific left and right end points used to generate the specific exponential curve, where the signal-to-noise ratio is calculated as the signal value divided by the noise value.

The method 900 also includes determining a nanoparticle threshold for each of the exponential curves based on the calculated signal-to-noise ratio in block 910. For example, the controller 108 can determine the nanoparticle threshold as being the histogram value that is greater than (e.g., one increment to the right on the histogram) a signal-to-noise ratio value that is less than a threshold signal to noise ratio (e.g., S/N=1.05). In implementations, the controller 108 begins analysis with the furthest bar of histogram on the right and progresses in the left direction to determine the first occurrence where the signal-to-noise ratio is less than given signal-to-noise threshold, for example 1.05. The last bar above the signal-to-noise threshold (e.g., above 1.05) is assigned as the nanoparticle threshold for the data set analyzed with that particular exponential curve. For example, if a histogram provides a progression from left to right of signal-to-noise ratios of 0.76, 0.82, 0.94, 1.02, 1.064, 1.12, 1.3, 2.76, 5.3, 12.9, and the signal-to-noise threshold is 1.05, then the controller 108 will assign the frequency of the intensity value for the nanoparticle threshold at 1.064 (i.e., the histogram value where the S/N value is greater than the first occurrence where the signal-to-noise ratio is less than the signal-to-noise threshold).

The nanoparticle threshold can also be determined using a fixed number of consecutive signal-to-noise ratio values (e.g., a window of values) that are below the signal-to-noise threshold. For instance, the method 900 can include determining where two, three, four, or more consecutive values of the signal-to-noise ratio are below the signal-to-noise threshold. For example, if a histogram provides a progression from left to right of signal-to-noise ratios of 0.76, 0.82, 1.15, 1.02, 1.064, 1.12, 1.3, 2.76, 5.3, 12.9 and the nanoparticle threshold detection step of block 910 in method 900 includes a detection window of two and a signal-to-noise threshold of 1.05, then the nanoparticle detection threshold will be 1.15, since the two adjacent values to the left are both below the signal-to-noise threshold of 1.05. For instance, while the histogram includes 1.064 as the first value adjacent to a signal-to-noise value that is less than the threshold (i.e., 1.02 is less than 1.05), the value of 1.02 is adjacent to a value that exceeds 1.05 (i.e., 1.15 is greater than 1.05) and so is not the nanoparticle detection threshold for a detection window of two.

The method also includes determining whether the nanoparticle threshold is greater than the right end point used to generate the exponential curve in block 912. For example, the controller 108 can compare the nanoparticle threshold determined in block 910 to the right end point used in block 906 to generate a given exponential curve to determine whether the nanoparticle threshold is greater than the right end point. If the nanoparticle threshold is less than the right end point (i.e., the decision at block 912 is No), then the method 900 proceeds to block 914, where the exponential curve is rejected as the ionic noise curve. If the nanoparticle threshold is greater than the right end point (i.e., the decision at block 912 is Yes), then the method 900 proceeds to block 916, where the nanoparticle threshold and associated exponential curve that includes the most values on the histogram is selected for data analysis of the histogram. For example, the controller 108 would select the nanoparticle threshold and associated exponential curve for curve 716 with right end 714 from FIG. 7C instead of curve 704 with right end 700 from FIG. 7A, since the histogram between left end 712 and right end 714 includes more values of the histogram than the histogram between left end 702 and right end 700.

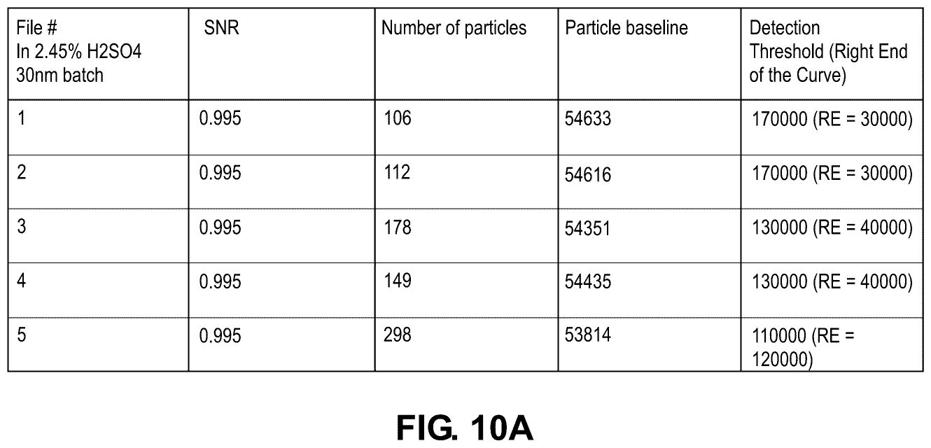

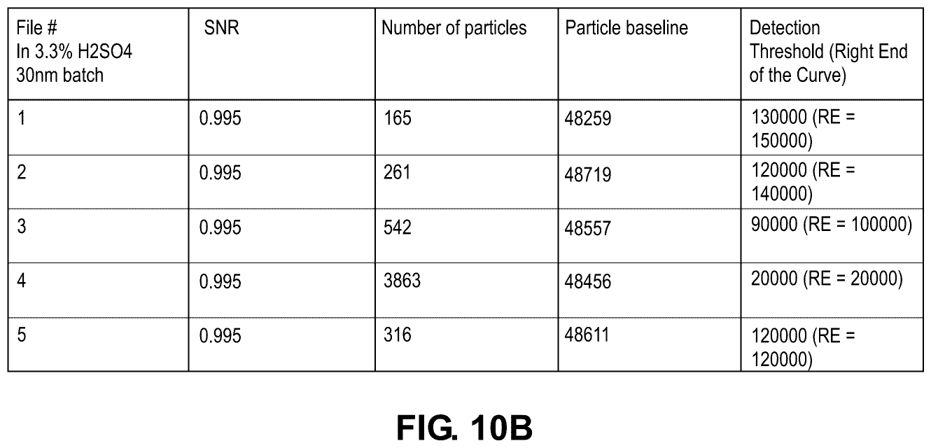

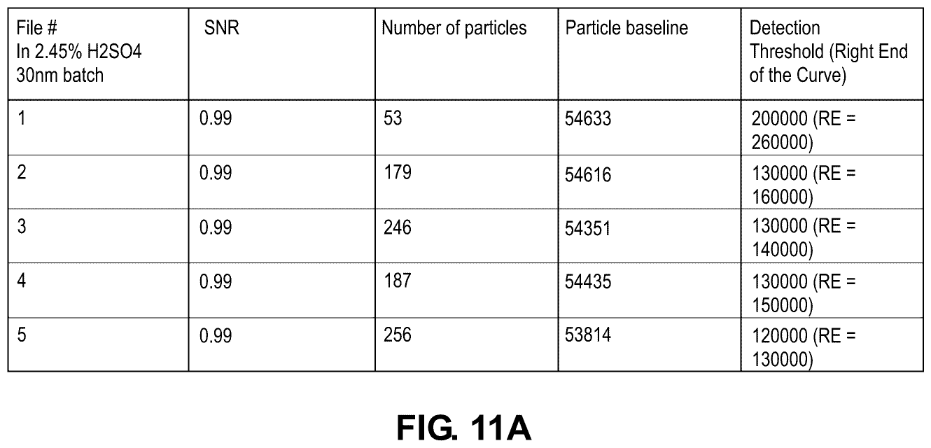

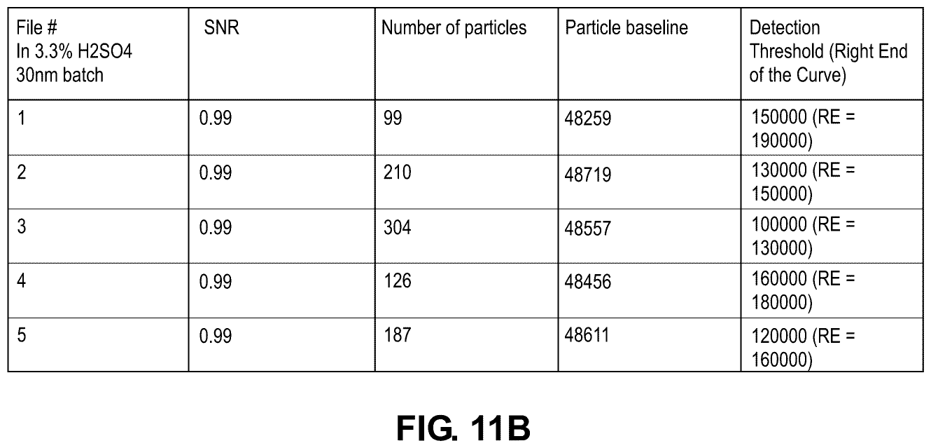

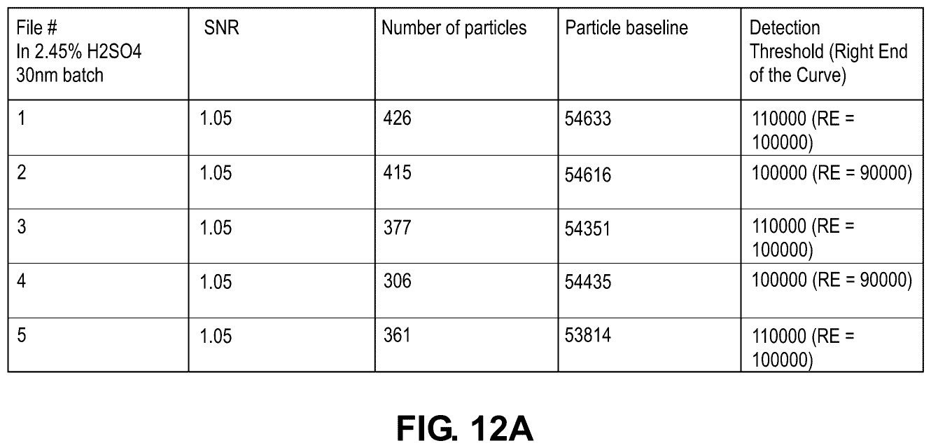

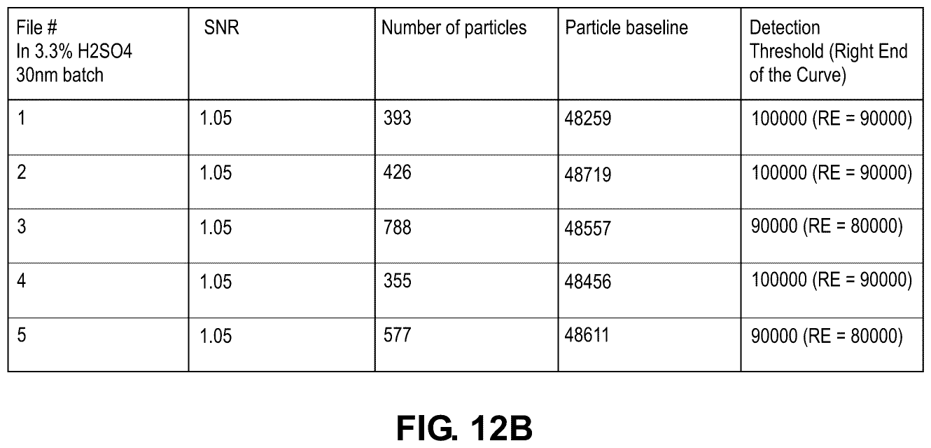

Referring to FIGS. 10A through 12B, example datasets are provided that show treatment of a spectrometry dataset according to utilization of the coefficient of determination (R²) for determination of the right end of the exponential curve (FIGS. 10A through 11B) and according to utilization of a signal-to-noise ratio for determination of the right end of the exponential curve (FIGS. 12A through 12B). For instance, FIGS. 10A, 11A, and 11B correspond to treatment of sample data involving 30 nm Si nanoparticles present in 2.45% sulfuric acid, whereas FIGS. 10B, 11B, and 11C correspond to treatment of sample data involving 30 nm Si nanoparticles present in 3.3% sulfuric acid. For the analysis of the data involved in FIGS. 10A and 10B, the coefficient of determination (R²) limit was set to 0.995, whereas for the analysis of the data involved in FIGS. 11A and 11B, the coefficient of determination (R²) limit was set to 0.99. For the analysis of the data involved in FIGS. 12A and 12B, the signal-to-noise ratio limit was set to 1.05.

Electromechanical devices (e.g., electrical motors, servos, actuators, or the like) may be coupled with or embedded within the components of the system 100 to facilitate automated operation via control logic embedded within or externally driving the system 100. The electromechanical devices can be configured to cause movement of devices and fluids according to various procedures, such as the procedures described herein. The system 100 may include or be controlled by a computing system having a processor or other controller configured to execute computer readable program instructions (i.e., the control logic) from a non-transitory carrier medium (e.g., storage medium such as a flash drive, hard disk drive, solid-state disk drive, SD card, optical disk, or the like). The computing system can be connected to various components of the system 100, either by direct connection, or through one or more network connections (e.g., local area networking (LAN), wireless area networking (WAN or WLAN), one or more hub connections (e.g., USB hubs), and so forth). For example, the computing system can be communicatively coupled to the system controller, ICP torch, carriage motors, fluid handling systems (e.g., valves, pumps, etc.), other components described herein, components directing control thereof, or combinations thereof. The program instructions, when executed by the processor or other controller, can cause the computing system to control the system 100 according to one or more modes of operation, as described herein.

It should be recognized that the various functions, control operations, processing blocks, or steps described throughout the present disclosure may be carried out by any combination of hardware, software, or firmware. In some embodiments, various steps or functions are carried out by one or more of the following: electronic circuitry, logic gates, multiplexers, a programmable logic device, an application-specific integrated circuit (ASIC), a controller/microcontroller, or a computing system. A computing system may include, but is not limited to, a personal computing system, a mobile computing device, mainframe computing system, workstation, image computer, parallel processor, or any other device known in the art. In general, the term “computing system” is broadly defined to encompass any device having one or more processors or other controllers, which execute instructions from a carrier medium.

Program instructions implementing functions, control operations, processing blocks, or steps, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, a solid-state or flash memory device, or a magnetic tape.

### CONCLUSION

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims. It is apparent that various modifications and combinations of the structural features and/or process operations may be made by those skilled in the art without departing from the scope and spirit of the foregoing disclosure.

What is claimed is:

1. A method for determination of nanoparticle detection threshold of a fluid sample, comprising:
transferring a fluid sample containing nanoparticles to a spectrometry sample analyzer;
generating a spectrometry data set via the spectrometry sample analyzer associated with detected ion signal intensity over time;
establishing, via one or more computer processors, an ionic noise data set associated with background ion signal intensity by modeling the ionic noise as an exponential curve via regression analysis with a part of a frequency-intensity histogram of the spectrometry data set; and
subtracting, via the one or more computer processors, the ionic noise data set from the spectrometry data set to obtain a nanoparticle data set.

2. The method of claim 1, wherein the spectrometry sample analyzer is an inductively coupled plasma mass spectrometer (ICPMS).

3. The method of claim 2, wherein transferring a fluid sample containing nanoparticles to a spectrometry sample analyzer includes transferring the fluid sample from a fluid source to an inductively coupled plasma torch and subsequently to the ICPMS.

4. The method of claim 1, further comprising setting the nanoparticle detection threshold as an intensity value in the nanoparticle dataset that follows at least one intensity value that is below a threshold intensity.

5. The method of claim 1, further comprising setting the nanoparticle detection threshold as an intensity value in the nanoparticle dataset that follows two consecutive intensities values that are below a threshold intensity.

6. The method of claim 5, wherein the threshold intensity is zero.

7. The method of claim 1, wherein establishing, via one or more computer processors, an ionic noise data set associated with background ion signal intensity by modeling the ionic noise as an exponential curve via regression analysis with a part of a frequency-intensity histogram of the spectrometry data set includes:
establishing, via one or more computer processors, an ionic noise data set associated with background ion signal intensity by modeling the ionic noise as an exponential curve using a least squares fit with a part of a frequency-intensity histogram of the spectrometry data set.

8. The method of claim 1, wherein the part of the frequency-intensity histogram of the spectrometry data set is determined at least in part based on a signal-to-noise ratio of frequency values corresponding to each of an intensity of the frequency-intensity histogram and the intensity on the exponential curve.

9. The method of claim 8, wherein the part of the frequency-intensity histogram is bounded by a left end and a right end of intensity values of the frequency-intensity histogram, wherein the right end of the histogram is selected based on:
modeling the ionic noise as a plurality of exponential curves via regression analysis with using differing right end points on the frequency-intensity histogram of the spectrometry data set;
for each exponential curve, determining the signal-to-noise ratio of frequency values corresponding to each of an intensity of the frequency-intensity histogram and the intensity on the exponential curve;
for each signal-to-noise ratio, determining the nanoparticle threshold; and
determining which nanoparticle threshold is larger than the right end used for the respective exponential curve.

10. The method of claim 9, further comprising analyzing the spectrometry data set utilizing the nanoparticle threshold that is larger than the right end used for the respective exponential curve and includes more histogram intensity values than other nanoparticle thresholds that are larger than the right end used for the respective exponential curves.

11. A system for determination of nanoparticle detection threshold of a fluid sample, comprising:
a spectrometry sample analyzer configured to receive a fluid sample containing nanoparticles from a sample source and to generate a spectrometry data set associated with detected ion signal intensity over time;
one or more computer processors; and
a non-transitory computer readable-medium bearing one or more instructions for execution by the one or more computer processors to cause the one or more computer processors to perform the steps of:
generating a spectrometry data set via the spectrometry sample analyzer associated with detected ion signal intensity over time,
establishing an ionic noise data set associated with background ion signal intensity by modeling the ionic noise as an exponential curve via regression analysis with a part of a frequency-intensity histogram of the spectrometry data set, and
subtracting the ionic noise data set from the spectrometry data set to obtain a nanoparticle data set.

12. The system of claim 11, wherein establishing an ionic noise data set associated with background ion signal intensity by modeling the ionic noise as an exponential curve via regression analysis with a part of a frequency-intensity histogram of the spectrometry data set includes:
establishing an ionic noise data set associated with background ion signal intensity by modeling the ionic noise as an exponential curve using a least squares fit with a part of a frequency-intensity histogram of the spectrometry data set.

13. The system of claim 11, wherein the part of the frequency-intensity histogram of the spectrometry data set is determined at least in part based on a signal-to-noise ratio of frequency values corresponding to each of an intensity of the frequency-intensity histogram and the intensity on the exponential curve.

14. The system of claim 13, wherein the part of the frequency-intensity histogram is bounded by a left end and a right end of intensity values of the frequency-intensity histogram, wherein the right end of the histogram is selected based on:
modeling the ionic noise as a plurality of exponential curves via regression analysis with using differing right end points on the frequency-intensity histogram of the spectrometry data set;
for each exponential curve, determining the signal-to-noise ratio of frequency values corresponding to each of an intensity of the frequency-intensity histogram and the intensity on the exponential curve;
for each signal-to-noise ratio, determining the nanoparticle threshold; and
determining which nanoparticle threshold is larger than the right end used for the respective exponential curve.

15. The system of claim 14, further comprising analyzing the spectrometry data set utilizing the nanoparticle threshold that is larger than the right end used for the respective exponential curve and includes more histogram intensity values than other nanoparticle thresholds that are larger than the right end used for the respective exponential curves.

16. The system of claim 11, wherein the spectrometry sample analyzer is an inductively coupled plasma mass spectrometer (ICPMS).

17. The system of claim 16, further comprising an inductively coupled plasma torch fluidically coupled between the sample source and the ICPMS.

18. The system of claim 11, wherein the one or more instructions further include one or more instructions for setting the nanoparticle detection threshold as an intensity value in the nanoparticle dataset that follows at least one intensity value that is below a threshold intensity.

19. The system of claim 11, wherein the one or more instructions further include one or more instructions for setting the nanoparticle detection threshold as an intensity value in the nanoparticle dataset that follows two consecutive intensities values that are below a threshold intensity.

20. The system of claim 19, wherein the threshold intensity is zero.
